(19) United States
(12) Patent Application Publication
(10) Pub. No.: US 2026/0301362 A1
(43) Pub. Date: Oct. 1, 2026

(54) Method and Apparatus for Image and Training Data Processing, Electronic Device and Storage Medium

(71) Applicants: The Hong Kong Polytechnic University, Hong Kong (CN); Feelings Group Limited, Hong Kong (CN)

(72) Inventors: Wing Sze WONG, Hong Kong (CN); Chi Hay YIP, Hong Kong (CN); Cheung Leong TUNG, Hong Kong (CN); Kit Hon TSOI, Hong Kong (CN)

(73) Assignees: The Hong Kong Polytechnic University, Hong Kong (CN); Feelings Group Limited, Hong Kong (CN)

(21) Appl. No.: 19/566,942

(22) Filed: Mar. 13, 2026

(30) Foreign Application Priority Data
Mar. 14, 2025 (HK) 22025104728.2

(51) Int. Cl. G06V 10/46; G06V 10/82; G06V 20/70

(52) U.S. Cl. CPC G06V 10/462; G06V 10/82; G06V 20/70; G06V 2201/031

(57) ABSTRACT

The disclosure provides methods and apparatuses for image processing and asynchronous training data processing, electronic device and computer-readable storage medium, relating to artificial intelligence technical field. The method includes: obtaining a first image; inputting the first image into a directional state classifier to obtain a directional state and first direction confidence of a tongue in the first image; inputting the first image into a key point detector to obtain key point location and first location confidence of the tongue in the first image; and determining the first image as a candidate image based on the first direction and location confidence of the tongue in first image for supervised annotation. Determining to-be-annotated candidate image through first direction confidence of the directional state of the tongue in the detected image and the first location confidence of the location of the tongue reduces amount of data to be annotated and improves efficiency.

### CROSS-REFERENCE TO RELATED APPLICATION(S)

The present disclosure claims priority to Hong Kong Original Grant Standard Patent Application No. 22025104728.2, filed with the Hong Kong Intellectual Property Department on Mar. 14, 2025, entitled “Method For Detecting Tongue Key Points And Recognizing Behavioral Patterns”, the entire contents of which are incorporated herein by reference.

### TECHNICAL FIELD

The present disclosure relates to the field of artificial intelligence technologies, and in particular to an image processing method and apparatus, an asynchronous training data processing method and apparatus, an electronic device, and a computer-readable storage medium.

### BACKGROUND

Current facial recognition technologies, such as Mediapipe and YOLO, etc., have made advancements in facial recognition accuracy but fall short in accurately recognizing and tracking the real-time motion of a tongue. These technologies cannot meet recognition and medical diagnostic needs that require detection of oral and tongue conditions. There is currently no comprehensive and accurate model capable of real-time motion tracking and key point detection for the tongue. To train such a model in a conventional approach, a large dataset of tongue key point is needed, which requires significant manual workload. This is costly and prone to human error.

It should be noted that information disclosed in the background section above is only used to enhance the understanding of the background of the present disclosure, and therefore may include information that does not constitute prior art known to those skilled in the art.

### SUMMARY

A technical problem that the present disclosure aims to solve is to reduce the amount of manual work involved in image processing.

According to an aspect of the present disclosure, an image processing method is provided. The method including: obtaining a first image including a tongue; inputting the first image into a directional state classifier to obtain a directional state and first direction confidence of the tongue in the first image; inputting the first image into a key point detector to obtain a key point location and first location confidence of the tongue in the first image; and determining the first image as a candidate image according to the first direction confidence and the first location confidence of the tongue in the first image so as to perform supervised annotation.

In an embodiment, the method further includes: training the directional state classifier and the key point detector using the candidate image after annotation.

In an embodiment, determining the first image as the candidate image according to the first direction confidence and the first location confidence of the tongue in the first image includes: determining the image as the candidate image according to the first direction confidence and the first location confidence of the tongue in the first image, and consistency of the directional state and the key point location of the tongue in the first image.

In an embodiment, the directional state of the tongue includes: up, down, left, right, pending, unseen.

In an embodiment, the key point location of the tongue includes: a tip of the tongue, a root of the tongue, a middle point of the tongue, a left edge of the tongue, and a right edge of the tongue.

In an embodiment, the root of the tongue includes a left edge of the root of the tongue, a center of the root of the tongue, and a right edge of the root of the tongue.

The first image is a candidate image, i.e., a candidate image selected in this round based on confidence and consistency (a sample to be annotated, and is used for training after annotation). The second image is a non-candidate image in this round, referring to a sample that is not selected in this round, does not participate in this round of training, but its confidence and consistency are obtained through model inference before and after training to calculate a delta change and is used for the next round of candidate selection; the sample may be selected as a candidate in the next batch if it meets condition(s) of confidence, consistency, and delta change. In an embodiment, the method further includes: obtaining a second image including a tongue, wherein the second image refers to a non-candidate image in this round; inputting the second image into the directional state classifier to obtain a first directional state and first direction confidence of the tongue in the second image; inputting the second image into the key point detector to obtain a first key point location and first location confidence of the tongue in the second image; determining the second image to be a non-candidate image according to the first direction confidence and the first location confidence of the tongue in the second image; inputting the second image into the directional state classifier after training to obtain a second directional state and second direction confidence of the tongue in the second image; inputting the second image into the key point detector after training to obtain a second key point location and second location confidence of the tongue in the second image; and determining the second image as a candidate image according to a delta change on confidence of the directional state and the key point location of the second image, so as to perform the supervised annotation.

In an embodiment, the delta change on confidence is equal to confidence after training minus confidence before training; determining the second image as the candidate image according to the delta change on confidence of the directional state and the key point location of the second image includes: if the delta change on confidence of the directional state of the second image and/or the delta change on confidence of the key point location of the second image are negative, determining the second image to be the candidate image.

In an embodiment, the method further includes: determining the directional state of the tongue in the first image specifically includes: determining a bounding box of a mouth part to fit lips; through a relative location of a tip of the tongue relative to a middle point of the bounding box and a key point of a root of the tongue, forming positive and negative changes in an angle of an arrow relative to a Y-axis of a face relative coordinate system to further determine changes of the tongue in four directions of up, down, left, and right; determining an angle of deflection of the tongue through multiple key points of the tip of the tongue, and if the angle of deflection is within a specified threshold angle, determining the tongue as a “pending” state, that is, the tongue has been recognized but does not stick out in any direction; and determining a failure to detect the tip or root part of the tongue as a “unseen” state.

In an embodiment, the method further includes: when a root of the tongue is visible, setting three key points that form an arrow shape for the tip and root of the tongue, respectively, wherein the three key points of the root of the tongue are set at a middle point of the root of the tongue, a left edge of the root of the tongue and a right edge of the root of the tongue; for the three key points on the tip of the tongue, fixing a center point of the tip of the tongue as an exact location of the tip of the tongue, and extending other two points to a middle point of a left edge of the tongue and a middle point of a right edge of the tongue, respectively, to determine an approximate direction of the tip of the tongue and the exact location of the tip of the tongue; determining an overall direction of the tongue through an angle of deflection between the three key points of the tip of the tongue; calculating coordinates of a middle point through a distance between an exact point of the tip of the tongue and the middle point of the root of the tongue in a spatial dimension, and then according to a threshold value of the “pending” state, determining a region of the “pending” state by the distance of the middle point.

In an embodiment, when the root of the tongue is not visible, for the three key points on the tip of the tongue, the center point of the tip of the tongue is fixed as the exact location of the tip of the tongue, and the other two key points are extended to the middle point of the left edge of the tongue and the middle point of the right edge of the tongue, respectively, to determine the direction of the tip of the tongue and the exact location of the tip of the tongue; the overall direction of the tongue is determined through the angle of deflection between three key points of the tip of the tongue; and the coordinates of the middle point are calculated through a distance between the exact point of the tip of the tongue and a center point of the mouth part in the spatial dimension, and then according to the threshold value of the “pending” state, determining the region of the “pending” state by the distance of the middle point.

In an embodiment, determining the consistency based on the directional state and key point location of the tongue in the first image includes: determining directional information of the tongue in the first image based on the key point location of the tongue in the first image; and determining the consistency based on the directional state of the tongue in the first image and the directional information of the tongue in the first image.

According to another aspect of the present disclosure, there is provided an asynchronous training data processing method, including: inputting image samples including tongues into a directional state classifier to obtain first directional states and first direction confidence of tongues in respective image samples; inputting the image samples into a key point detector to obtain first key point locations and first location confidence of the tongues in respective image samples; determining a first candidate image in the image samples according to the first direction confidence and the first location confidence of the tongues in the image samples for supervised annotation; training the directional state classifier and the key point detector using the first candidate image after the supervised annotation; inputting non-candidate images in the image samples into the directional state classifier after training to obtain second directional states and second direction confidence of tongues in the non-candidate images; inputting the non-candidate images into the key point detector after training to obtain second key point locations and second location confidence of the tongues in the non-candidate image; selecting a second candidate image from the non-candidate images according to a delta change on confidence of the directional states and key point locations of the non-candidate images for supervised annotation; and training the directional state classifier and the key point detector using second candidate image after the supervised annotation.

In an embodiment, the method further includes: determining first consistency according to the first directional states and the first key point locations of the tongues in the image samples; determining the first candidate image in the image samples according to the consistency of the image samples for supervised annotation; and
determining second consistency of the non-candidate images according to the second directional states and the second key point locations of the tongues in the non-candidate image; determining the second candidate image in the non-candidate images according to a delta change on consistency of the non-candidate images for supervised annotation.

In an embodiment, the directional state of the tongue includes: up, down, left, right, pending, unseen; and/or
the key point location of the tongue includes: a tip of the tongue, a root of the tongue, a middle point of the tongue, a left edge of the tongue, and a right edge of the tongue.

In an embodiment, the root of the tongue includes a left edge of the root of the tongue, a center of the root of the tongue, and a right edge of the root of the tongue.

According to another aspect of the present disclosure, there is provided an image processing apparatus, including: an image obtaining module configured to obtain a first image including a tongue; a confidence obtaining module configured to input the first image into a directional state classifier to obtain a directional state and first direction confidence of the tongue in the first image, and input the first image into a key point detector to obtain a key point location and first location confidence of the tongue in the first image; and a candidate image determination module configured to determine the first image as a candidate image according to the first direction confidence and the first location confidence of the tongue in the first image so as to perform supervised annotation.

According to another aspect of the present disclosure, there is provided an asynchronous training data processing apparatus, including: a first confidence obtaining module configured to input image samples including tongues into a directional state classifier to obtain first directional states and first direction confidence of tongues in respective image samples, and input the image samples into a key point detector to obtain first key point locations and first location confidence of the tongues in respective image samples; a first candidate image determination module configured to determine a first candidate image in the image samples according to the first direction confidence and the first location confidence of the tongues in the image samples for supervised annotation; a training module configured to train the directional state classifier and the key point detector using the first candidate image after the supervised annotation; a second confidence obtaining module configured to input non-candidate images in the image samples into the directional state classifier after training to obtain second directional states and second direction confidence of tongues in the non-candidate images, and input the non-candidate images into the key point detector after training to obtain second key point locations and second location confidence of the tongues in the non-candidate image; a second candidate image determination module configured to select a second candidate image from the non-candidate images according to a delta change on confidence of the directional states and key point locations of the non-candidate images for supervised annotation; wherein the training module is further configured to train the directional state classifier and the key point detector using second candidate image after the supervised annotation.

According to another aspect of the present disclosure, there is provided an electronic device including: a processor; and a memory for storing executable instructions for the processor; wherein the processor is configured to perform the image processing method or the asynchronous training data processing method described above by executing the executable instruction.

According to another aspect of the present disclosure, there is provided a computer-readable storage medium. A computer program is stored on the computer-readable storage medium. When the computer program is executed by a processor, the image processing method or the asynchronous training data processing method described above is implemented.

The present disclosure provides a method for detecting tongue key points and recognizing behavior patterns, which is achieved through the following steps:
employing a classifier to determine six fundamental directional states (up/down/left/right/pending/unseen) of the tongue;
employing a key point detector to identify the visibility and location of the tongue key points, including the tip, root (left/right/center), middle points, left edges and right edges;
combining the value and delta change (before/after last round of training) on confidence and consistency of directional classification and key point detection to prioritize data samples with lower confidence and low consistency among the two models for manual annotation, where the data after annotation is used for machine learning in an iterative manner;
designing an asynchronous candidate queuing method to enable parallel operations of manual data annotation and model training, continuously updating the priority of data samples for manual annotation to reduce the required amount of annotated data samples.

By employing the aforementioned methods, the present disclosure is capable of reducing the manual annotation workload for tongue key point datasets while enhancing the model's accuracy and robustness, meeting the medical diagnostic needs for detecting conditions of the oral cavity and tongue.

Furthermore, the present disclosure aims to diminish the manual annotation effort required to train a tongue key point detection model through the design and implementation of mechanism to short list a subset of unlabeled data sample(s) to be annotated for model training, reducing the manual effort to annotate the location and visibility of tongue key points and pose. Utilizing adaptive machine learning techniques, the present disclosure can enable training of computer vision models based on partially annotated dataset, which includes six fundamental orientations of the tongue (up, down, left, right, pending, and unseen), as well as detecting the location and visibility of tongue key points (such as the tip, root (center/left/right), middle points, left edge, and right edge), which can be used to analyze the tongue posture for oral motor analysis. The present disclosure dynamically shortlists unlabeled data for manual annotation based on the value and delta change of confidence levels, variations and consistency level of tongue direction classifier and tongue key point detector, prioritizing controversial training samples for model training. To further utilize the annotated data sample and reduce the amount of annotated data sample needed, the present disclosure designs an asynchronous candidate queuing mechanism to parallelize the progress of data annotation, model training, and annotation candidate evaluation. The present disclosure reduces the workload associated with tongue key point dataset annotation.

It should be understood that the above general description and the following detailed description are illustrative and explanatory only, and are not intended to limit the present disclosure.

### BRIEF DESCRIPTION OF THE DRAWINGS

The accompanying drawings, which are incorporated in and form part of the specification, illustrate embodiments consistent with the present disclosure and, together with the specification, serve to explain the principles of the present disclosure. It is obvious that the drawings described below are merely some embodiments of the present disclosure, and those skilled in the art can obtain other drawings based on these drawings without inventive effort.

FIG. 1 shows a flowchart of an image processing method according to an embodiment of the present disclosure;

FIG. 2 shows a flowchart of an image processing method according to another embodiment of the present disclosure;

FIG. 3 shows a flowchart of an image processing method according to yet another embodiment of the present disclosure;

FIG. 4 shows a schematic diagram of a tongue direction classifier according to an embodiment of the present disclosure;

FIG. 5 shows locations of key points of a tongue in an example of the present disclosure;

FIG. 6 shows a flowchart of consistency of tongue direction and tongue location detection according to an embodiment of the present disclosure;

FIG. 7 shows a flowchart of determining a direction of a tongue based on key point(s) of the tongue according to an embodiment of the present disclosure;

FIG. 8 shows an example of consistency determination according to an embodiment of the present disclosure;

FIG. 9 shows an interface diagram for training a tongue direction classifier according to an embodiment of the present disclosure;

FIG. 10 shows a flowchart of an asynchronous training data processing method according to an embodiment of the present disclosure;

FIG. 11 shows a flowchart of an asynchronous training data processing method according to another embodiment of the present disclosure;

FIG. 12 shows a structural diagram of an image processing apparatus according to an embodiment of the present disclosure;

FIG. 13 shows a structural diagram of an asynchronous training data processing apparatus according to an embodiment of the present disclosure;

FIG. 14 shows a structural block diagram of a computer device according to an embodiment of the present disclosure.

### DETAILED DESCRIPTION

Example implementations will now be described more fully with reference to the accompanying drawings. However, these example implementations can be implemented in many forms and should not be construed as limited to the examples set forth herein; rather, they are provided so that the present disclosure will be more comprehensive and complete, and will fully convey the concept of the example implementations to those skilled in the art. The described features, structures, or characteristics may be combined in any suitable manner in one or more implementations.

Furthermore, the accompanying drawings are merely illustrative of the present disclosure and are not necessarily drawn to scale. The same reference numerals in the drawings denote the same or similar parts, and therefore repeated descriptions of them will be omitted. Some block diagrams shown in the drawings are functional entities and do not necessarily correspond to physically or logically independent entities. These functional entities may be implemented in a form of software, in one or more hardware modules or integrated circuits, or in different network and/or processor apparatuses and/or microcontroller apparatuses.

The present disclosure aims to diminish the manual annotation effort required to train a tongue key point detection model through the design and implementation of mechanism to short list a subset of data samples to be annotated from unlabeled data samples for model training, reducing the manual costs to manually annotate the location and visibility of tongue key points and pose. Utilizing adaptive machine learning techniques, the present disclosure can enable training of computer vision models based on partially annotated dataset, which includes six fundamental orientations of the tongue (up, down, left, right, pending, and unseen), as well as detecting the location and visibility of tongue key points including the tip, root (center/left/right), middle points, left edge, and right edge. The detection result can be used for tongue posture evaluation in tongue motor function analysis.

The present disclosure dynamically shortlists unlabeled data and determines priority for manual annotation based on the value and delta change of confidence levels, variations and consistency level of tongue direction classifier and tongue key point detector, prioritizing samples with judgment disputes in model training as manual annotation targets.

To further maximize the utilization value of labeled data samples and meanwhile reduce the total number of labeled samples required for model training, the present disclosure further designs an asynchronous candidate sample queuing mechanism to parallelize the progress of three processes including data annotation, model training, and annotation candidate sample evaluation. The present disclosure effectively reduces the workload associated with the annotation of tongue key point datasets. The present disclosure introduces a method capable of training a tongue key point detection model while reducing the volume of annotated datasets, and also ensuring model accuracy and consistency.

The original intention in inventing the design pattern in the present disclosure is to reduce the manual effort on annotating a tongue key point datasets that is highly similar or redundant, hence contributing less to the effectiveness of tongue key point detection model training. Thus, a methodology to extract a subset of training data with high variance from the whole dataset is needed. This methodology should reduce the manual effort needed to perform data annotation (on this subset of training data) while achieving accurate and robust model performance. The variation can be reduced dynamically to enable fine tuning on the model accuracy.

An embodiment of the present disclosure uses two co-trained artificial intelligence models to recognize tongue pose: a tongue direction classification model (classifier) and a tongue key point detection model (detector). In an embodiment, the dataset is analyzed in two passes. In the first pass, the classifier estimates the tongue orientation (one of six states). In the second pass, the detector estimates the location of each tongue key point.

First part: the classifier estimates the tongue orientation in six states: up, down, left, right, pending, and unseen.

The “unseen” state means that the tongue is not visible in the image or video frame.

The “pending” state means that the tongue is visible but not sticking out of the month or not clearly pointing to a distinctive direction.

The “up/down/left/right” state means that the tongue is sticking out of the month and pointing to the corresponding direction.

Second part: the detector identifies the locations of the key points on the tongue, including the tip, root (center/left/right), and middle points on the left edge and right edge at the widest part. If the key point is covered (not visible), the key point should be recognized as covered instead of estimating a location out of sight. The detected key point location can be further utilized to analyze the tongue movement and trajectory.

The present disclosure uses the confidence and consistency on tongue orientation from both direction classifier and key point detector to evaluate the confusion degree of each data sample in iteration. This allows prioritizing the most contributive data samples that should to be annotated manually, reducing the manual effort needed to train the tongue key point detector for higher accuracy with limited annotated dataset.

In addition, the present disclosure uses a combination of confidence and delta change to dynamically adjust the priority of data to be annotated. Specifically, the present disclosure keeps track of the confidence and consistency of the tongue direction classifier and tongue key point detector before and after the last round of training. If the confidence and/or consistency of a sample data drops in the last round of training, it may hint that the particular data sample is in contradict with the models'understanding of the underlying representation. We prioritize the selection of these training samples for manual annotation. This method can direct the training process on a data sample that is confusing or controversial to the model's understanding.

In an embodiment, the present disclosure uses the confidence and consistency on tongue direction determination from both direction classifier and key point detector to evaluate the confusion degree of each data sample in each iteration. This allows us to prioritize the most contributive data samples that should to be annotated manually, reducing the manual effort needed to train the tongue key point detector for higher accuracy with limited annotated dataset.

In addition, the present disclosure uses a combination of confidence and delta change to dynamically adjust the priority of data to be annotated. Specifically, we keep track of the confidence and consistency of the tongue direction classifier and tongue key point detector before and after the last round of training. If the confidence and(or) consistency of a sample data drops in the last round of training, it may hint that the particular data sample is in contradict with the models'understanding of the underlying representation. We prioritizes the selection of these training samples for manual annotation. This method can direct the training process on a data sample that is confusing or controversial to the model's understanding.

Consideration of the manual data annotation is prioritized in this way to improve the model training efficiency with limited annotated dataset.

Prioritizing the manual data annotation in this way can improve the model training efficiency with limited annotated dataset.

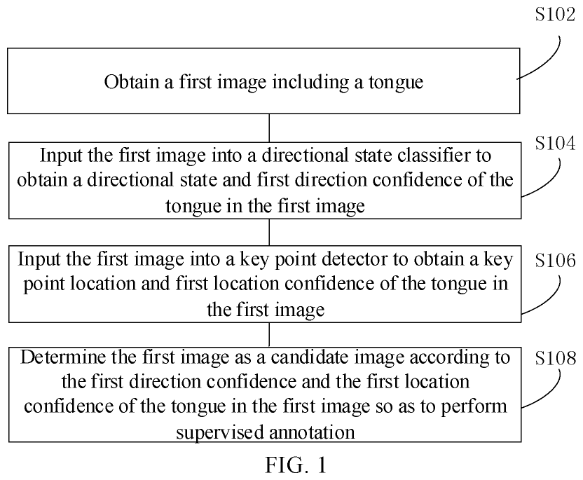

FIG. 1 shows a flowchart of an image processing method according to an embodiment of the present disclosure.

As shown in FIG. 1, in S102, a first image is obtained. The first image includes a tongue.

In S104, the first image is input into a directional state classifier to obtain a directional state and first direction confidence of the tongue in the first image. In an embodiment, the directional state of the tongue includes: up, down, left, right, pending, and unseen.

In S106, the first image is input into a key point detector to obtain a key point location and first location confidence of the tongue in the first image. In an embodiment, the key point location of the tongue includes: a tip of the tongue, a root of the tongue, a middle point of the tongue, a left edge of the tongue, and a right edge of the tongue. The root of the tongue may include a left edge of the root of the tongue, a center of the root of the tongue, and a right edge of the root of the tongue.

In S108, the first image is determined to be a candidate image based on the first direction confidence and the first location confidence of the tongue in the first image for supervised annotation. The supervised annotation may include for example manual annotation or other supervised annotation method(s). A first image with first direction confidence and/or first location confidence lower than a first threshold may be selected as a candidate image. A relatively low score may be selected as the first threshold. For example, 1 is the highest confidence, and 0.6 or 0.8 may be selected as the first threshold.

In an embodiment, for candidate image samples that meet a candidate criterion, the candidate images may be ranked or filtered according to a custom rule to determine samples to be annotated; the custom rule may be based on at least one of confidence or consistency.

In the above embodiments, candidate images for annotation are determined by the first direction confidence and the first location confidence of the tongue in the image under detection, which reduces the amount of data that needs to be annotated and improves efficiency.

By using the above method, the workload of manual annotation of tongue key point datasets can be reduced while improving the accuracy and robustness of the model, thus meeting the medical diagnostic needs for the detection of oral and tongue-related diseases.

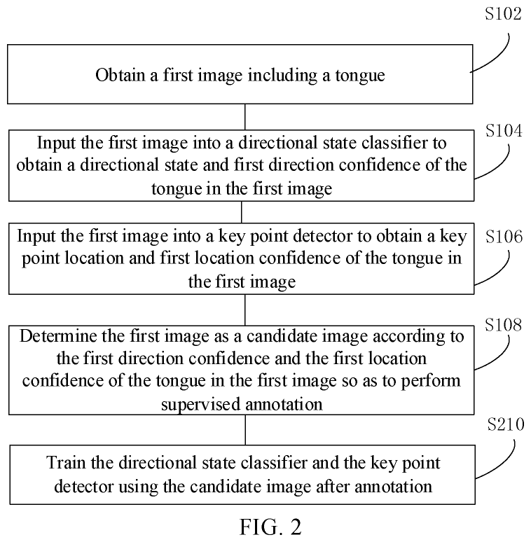

FIG. 2 shows a flowchart of an image processing method according to another embodiment of the present disclosure.

As shown in FIG. 2, regarding S102 to S108, reference can be made to the corresponding description in FIG. 1 above, and no detailed description will be provided here for the sake of brevity.

In S210, the directional state classifier and the key point detector are trained using the candidate image(s) annotation.

In the above embodiment, candidate image(s) that needs(need) to be annotated are selected in the above manner, and the candidate image(s) after annotation is(are) used to train the directional state classifier and the key point detector. On the one hand, the workload of annotation is reduced, and on the other hand, the training efficiency and the accuracy of the trained classifier and detector can be improved.

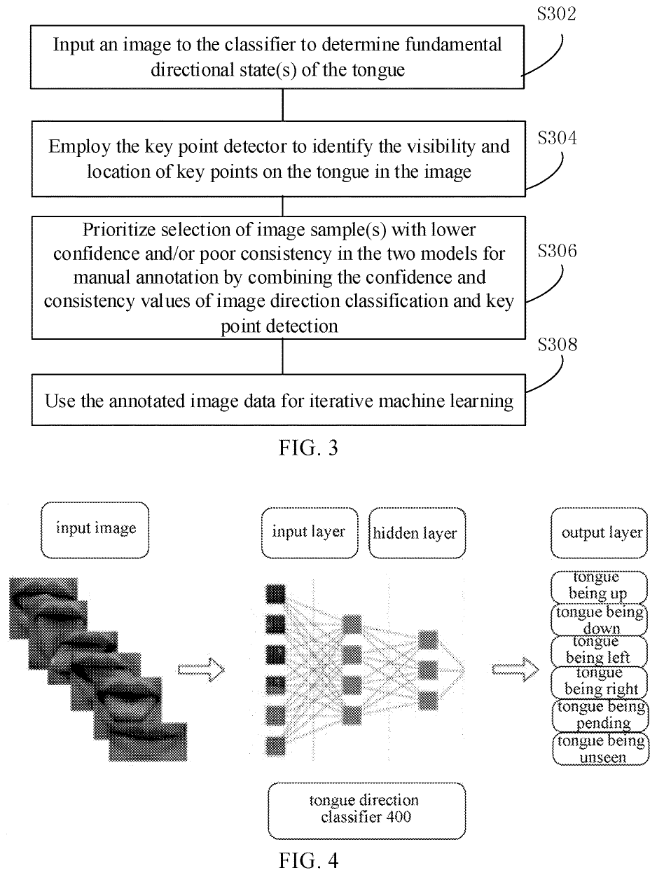

FIG. 3 shows a flowchart of an image processing method according to yet another embodiment of the present disclosure.

As shown in FIG. 3, in step S302, an image is input to the classifier to determine fundamental directional state(s) of the tongue.

In S304, the key point detector is employed to identify the visibility and location of key points on the tongue in the image.

In S306, selection of image sample(s) with lower confidence and/or poor consistency in the two models is prioritized for manual annotation by combining the confidence and consistency values of image direction classification and key point detection.

In S308, the annotated image data is used for iterative machine learning of the classifier and detector.

In the above embodiment, combining confidence and consistency to select image sample(s) that requires(require) manual annotation for iterative machine learning of the classifier and detector results in more targeted image sample(s) and better training performance.

FIG. 4 shows a schematic diagram of a tongue direction classifier according to an embodiment of the present disclosure. As shown in FIG. 4, the tongue direction classifier 400 includes an input layer, a hidden layer, and an output layer. An image for training is input into the classifier, and the classifier outputs the directional state(s) of the tongue, such as tongue being up, tongue being down, tongue being left, tongue being right, tongue being pending, and tongue being unseen, etc.

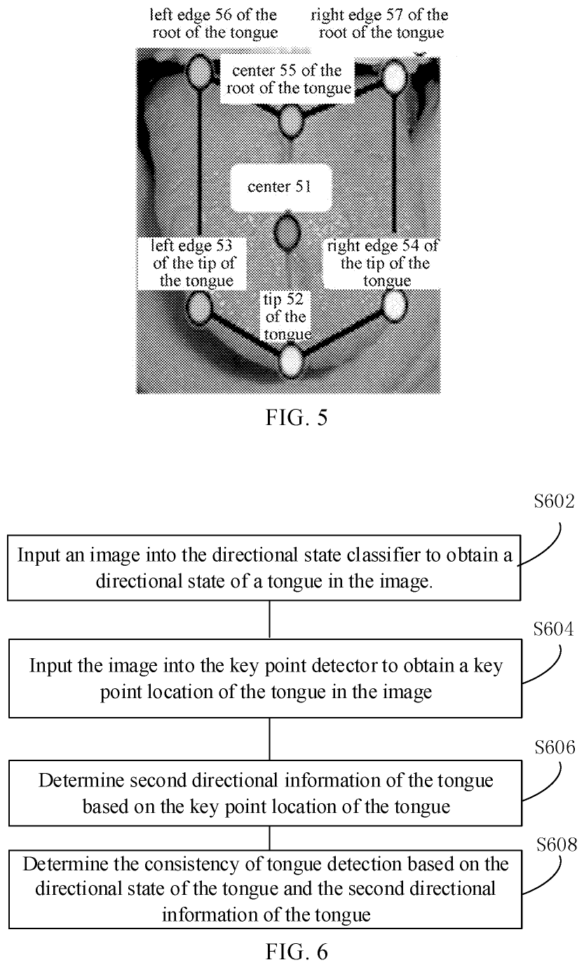

FIG. 5 illustrates key point locations of a tongue in an example of the present disclosure. As shown in FIG. 5, the key point locations of the tongue include a center 51, a tip 52 of the tongue, a left edge 53 of the tip of the tongue, a right edge 54 of the tip of the tongue, and a root of the tongue (including a center 55 of the root of the tongue, a left edge 56 of the root of the tongue, and a right edge 57 of the root of the tongue).

FIG. 6 shows a flowchart of the consistency of tongue direction and tongue location detection according to an embodiment of the present disclosure.

As shown in FIG. 6, in S602, an image is input into the directional state classifier to obtain a directional state of a tongue in the image.

In S604, the image is input into the key point detector to obtain a key point location of the tongue in the image.

In S606, second directional information of the tongue is determined based on the key point location of the tongue.

In S608, the consistency of tongue detection is determined based on the directional state of the tongue and the second directional information of the tongue.

By verifying the consistency between the directional state of the tongue and the direction of the tongue determined by the key point on the tongue, image(s) with the potential for confusion can be selected for manual annotation.

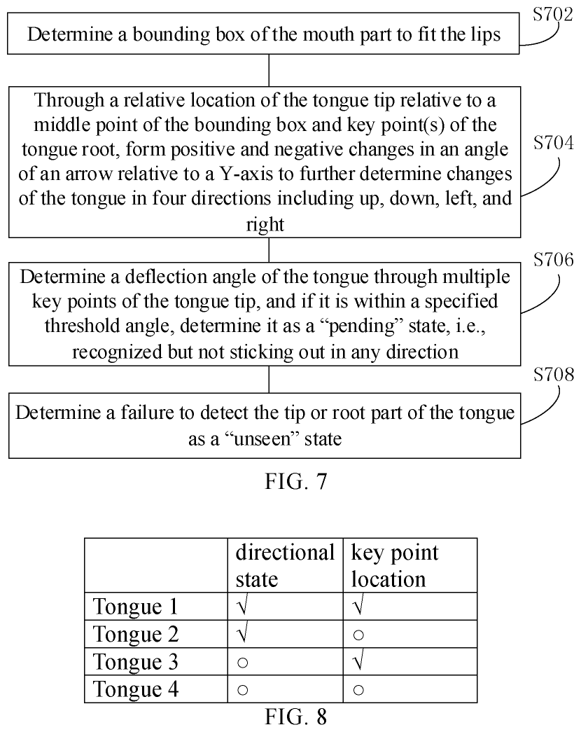

FIG. 7 shows a flowchart of determining a direction of the tongue based on key point(s) of the tongue in an embodiment of the present disclosure.

As shown in FIG. 7, in S702, a bounding box of a mouth part is determined to fit lips.

In S704, through a relative location of the tongue tip with respect to a middle point of the bounding box and key point(s) of the tongue root, positive and negative changes in an angle of an arrow relative to a Y-axis are formed, thereby determining the changes of the tongue in the four directions of up, down, left, and right.

In S706, in a case of the “pending” state, if the angle of the tongue tip remains within a specified threshold, an angle of deflection of the tongue is determined through multiple key points of the tongue tip. At this time, it is determined as recognized but not pointing to any direction. The tongue deflection angle is determined by multiple key points of the tongue tip. If it is within a specified threshold angle, it is determine as the “pending” state, that is, recognized but not sticking out in any direction.

In S708, if the tip or root part of the tongue cannot be detected, it is determined as a “unseen” state. In this way, different movement states of the tongue can be efficiently and accurately determined and categorized.

FIG. 8 illustrates an example of consistency determination in an embodiment of the present disclosure. As shown in FIG. 8, the directional state of the tongue in the first image is consistent with the judgment based on the key point location. Inconsistencies are observed in the judgments of the second and third images. The judgments in the fourth image are all incorrect.

First, the bounding box of the mouth part is marked to fit the lips, and then through the relative position of the tip of the tongue to the midpoint of the bounding box and the key points of the tongue root to form positive and negative changes in the angle of the arrows relative to the Y-axis to ensure the correctness of the tongue direction, to determine the changes of the tongue in the four directions including up, down, left, and right. In the case of the “pending” state, the angle of deflection of the tongue is determined through multiple key points of the tip of the tongue if it is kept within the specified threshold value, then it is judged to be recognized but not pointing in any direction. We will judge the tongue deflection angle by the multiple key points of the tip of the tongue if it stays within the threshold angle we stipulated, it will be judged as a “pending” state, i.e., it has been recognized but does not stick out in any direction. Finally, if we can't detect the tip of the tongue or the root part of the tongue, it will be judged as a “no-visibility” state. In this way, we can judge and categorize the different action states of the tongue with high efficiency and accuracy. The face relative coordinate system here is a coordinate system established based on the face itself, avoiding the influence caused by face facial tilt or head turning.

Key points are used to mark each part of the tongue to ensure that each part can be recognized and distinguished. When the root of the tongue is visible, three key points that form an arrow shape are set for the tip and the root of the tongue, respectively. For the three key points at the tip of the tongue, the center point of the tip of the tongue is fixed as an exact location of the tip of the tongue, and the other two key points are extend to the middle points of the left and right edges of the tongue, respectively. This determines the approximate direction and exact location of the tip of the tongue. The three key points at the root of the tongue are set at the middle point of the root of the tongue, and left edge and right edge of the root of the tongue. This allows the overall direction of the tongue to be determined by the deflection angle between the three key points at the tip of the tongue, as the deflection of the root of the tongue often determines the exact direction of the entire tongue. Then, the coordinate(s) of the middle point is(are) calculated using the distance between the exact point of the tip of the tongue and the middle point of the root of the tongue in a spatial dimension. Then, based on a threshold of the “pending” state, a region of the “pending” state is determined by the distance of the middle point. This further optimizes the efficiency and accuracy of recognizing respective parts of the tongue and motion states of the tongue. When the root of the tongue is not visible, for the three key points of the tongue tip, the center point of the tongue tip is fixed as the exact location of the tongue tip. The other two key points are extended to the middle points of the left and right edges of the tongue, respectively, thus determining the direction of the tongue tip and exact location of the tongue tip. The overall direction of the tongue is determined by the deflection angle between the three key points of the tongue tip. The coordinate(s) of the middle point is(are) calculated by the distance between the exact point of the tongue tip and the center point of the mouth part in spatial dimension. Then, based on the threshold of the “pending” state, the region of the “pending” state is determined by the distance of the middle point. The distance here may be a relative distance, such as a normalized distance, i.e., a distance unaffected by the shooting distance.

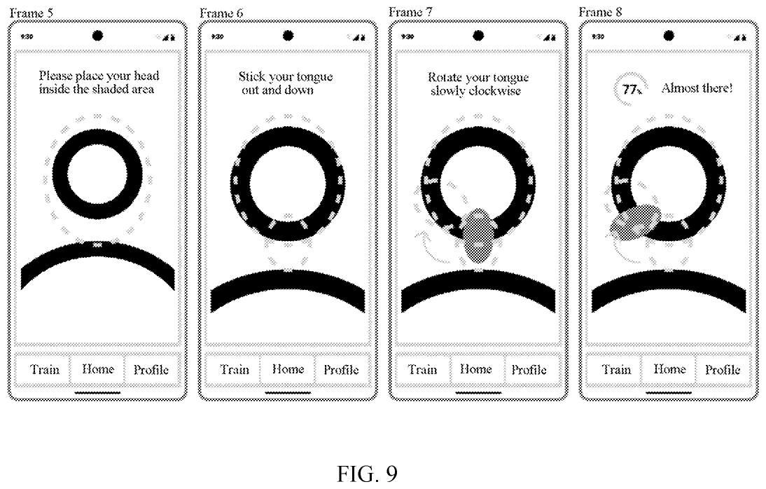

FIG. 9 shows a schematic interface for training a tongue direction classifier according to an embodiment of the present disclosure. As shown in FIG. 9, images of users'tongues are collected to train the tongue direction classifier. The collection of the tongue images can be accomplished through an application program (APP). Using the camera of a mobile phone hosting the APP, a user is prompted to adjust the location and direction of his/her tongue via a text prompt or a voice prompt to collect the image of the tongue. First, the user is prompted to place his/her tongue in the shaded area (the area circled by the dotted line). Whether the user's tongue is positioned correctly is determined by collecting images of the user's tongue. Then, the user is prompted to stick out his/her tongue upwards or downwards; the user also prompted to rotate his/her tongue, for example, slowly in a clockwise or counterclockwise direction. Finally, the user's tongue is detected to be rotated to its maximum location. During the process of the user adjusting and rotating his/her tongue, images of the user's tongue at a predetermined location are collected and then used for training of the tongue direction classifier.

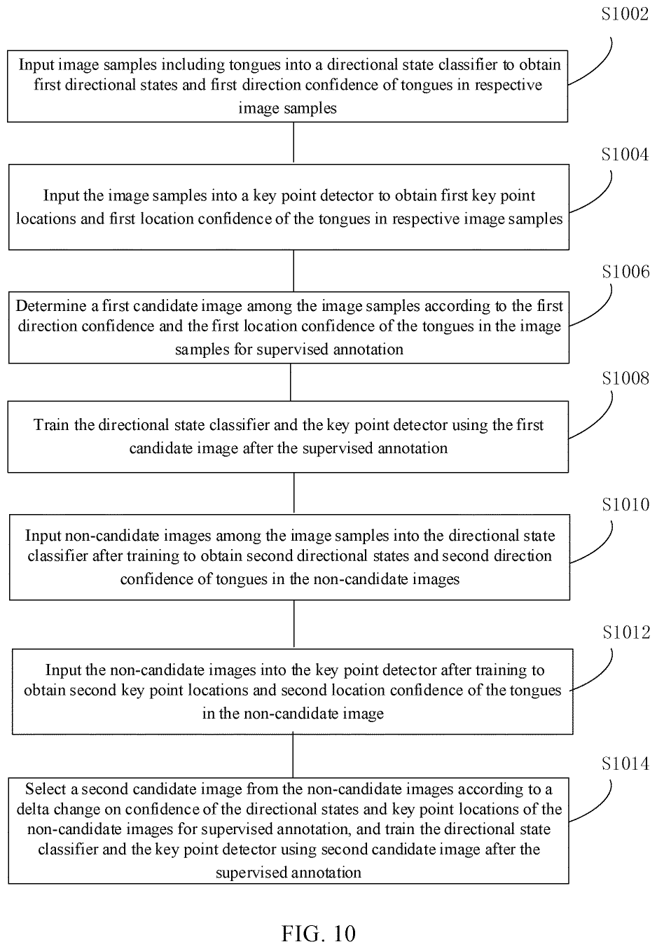

FIG. 10 shows a flowchart of an asynchronous training data processing method according to an embodiment of the present disclosure.

As shown in FIG. 10, in step S1002, image samples are input into a directional state classifier, where the image samples include tongues, and first directional states and first direction confidence of the tongues in respective image samples are obtained.

In S1004, the image samples are input into a key point detector to obtain first key point locations and first location confidence of the tongues in respective image sample.

In S1006, based on the first direction confidence and first location confidence of the tongues in the image samples, a first candidate image is determined among the image samples for supervised annotation. The first candidate image refers to a sample to be annotated in this round based on confidence and consistency, and is used for training after annotation. This sample may also be called a candidate image of a first image. Image samples not selected are non-candidate images, called second images, that is, samples that are not selected in this round, do not participate in this round of training, but confidence and consistency are obtained through model inference before and after training to calculate a delta change, and are used for the next round of candidate selection; if the condition such as confidence, consistency and delta change are met, the samples can be selected as the next batch of candidates.

In S1008, the directional state classifier and the key point detector are trained using the first candidate image after supervised annotation.

In S1010, the non-candidate images, i.e., the second images, among the image samples are input into the trained directional state classifier to obtain second directional states and second direction confidence of the tongues in the non-candidate images.

In S1012, the non-candidate images are input into the trained key point detector to obtain second key point locations and second location confidence of the tongues in the non-candidate images.

In S1014, a second candidate image (i.e., a candidate image of a second image) is selected from the non-candidate images based on a delta change on confidence of the directional states and key point locations of the non-candidate images for supervised annotation; the directional state classifier and the key point detector are trained using the supervised annotated second candidate image.

It should be noted that the delta change is not provided in the first round of candidate selection; the parameter of delta change on confidence is available in subsequent rounds and can be incorporated into the selection of candidate images.

In an embodiment, the condition for the delta change is a relative condition. For example, when there is no negative change in all samples, the selection of candidate images can be based on confidence and consistency.

In an embodiment, among the determined candidate image samples that meet the candidate criterion, the candidate images may be ranked or filtered according to a custom rule to determine samples to be annotated; the custom rule may be based on at least one of confidence, consistency, or its variation. For example, all candidate images may be ranked according to confidence; for the ranked candidate images, the top N candidate images may be selected.

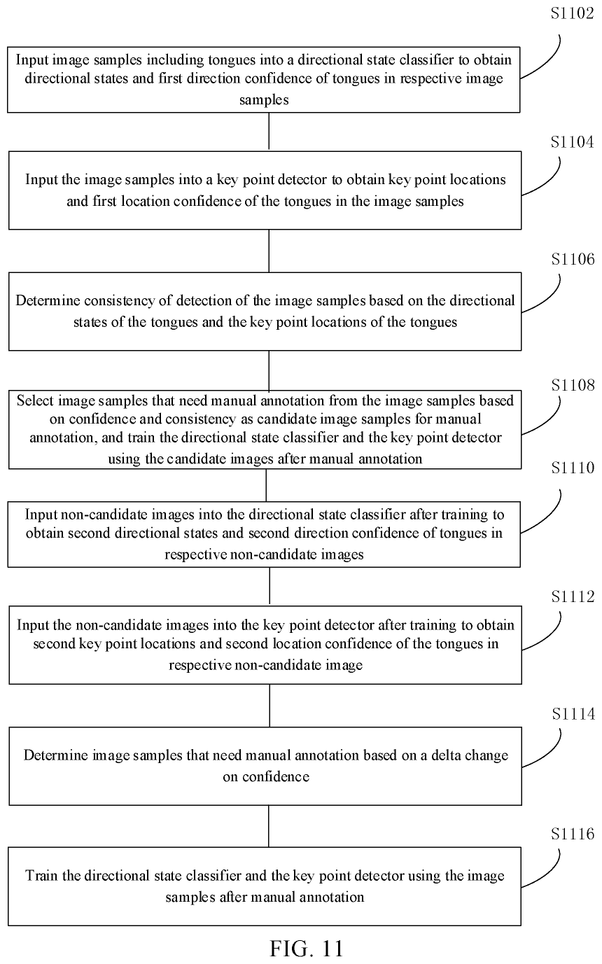

FIG. 11 shows a flowchart of an asynchronous training data processing method according to another embodiment of the present disclosure.

As shown in FIG. 11, in step S1102, image samples are input into the directional state classifier to obtain directional states and first direction confidence of tongues in respective samples in the image samples.

In S1104, the image samples are input into the key point detector to obtain key point locations and first location confidence of the tongues in respective samples in the image samples.

In S1106, detection consistency of the image samples is determined based on the directional states of the tongues and the key point locations of the tongues.

In S1108, based on confidence and consistency, image samples that need manual annotation are selected from the image samples as candidate image samples manual annotation. Image samples that are not selected are considered as non-candidate image samples. The manually annotated candidate images are then used to train the directional state classifier and key point detector.

In S1110, the non-candidate image samples are input into the trained directional state classifier to obtain second direction confidence of the second directional states of the tongues in respective non-candidate image samples.

In S1112, the non-candidate image samples are input into the trained key point detector to obtain second location confidence of the second key point locations of the tongues in respective non-candidate image samples.

In S1114, second candidate image samples that need to be manually annotated are determined based on the delta change on confidence.

In S1116, after manual annotation of the second candidate image samples, the manually annotated image samples are used to train the direction classifier and key point detector.

The present disclosure designs an asynchronous candidate queuing mechanism. While we iteratively annotate a sequence of unlabelled data determined with the above mentioned prioritizing strategies, at the same time the two models are using the annotated data to perform the training process. The annotated tongue visibility, pose direction, and key point location data can be used to train for both the direction classifier and key point detector models. While s batch of training is finished, we will use the two models to re-evaluate the rest of unlabeled data samples for confidence scoring and consistency scoring, and update the delta changes, which are then used to re-prioritize the data annotation candidates. In contrast to a typical supervised machine learning process where data annotation is done manually in batch, then the model performs machine learning on the fully annotated dataset, our design can leverage the newly annotated data as soon as possible, avoid asking the operator to continue annotate on data sample that is less constructive to the model training. This parallel iteration is repeated until the tongue key point classifier can correctly detect the location and visibility of the rest of data in a satisfying level of confidence and consistency. This asynchronous and parallel data annotating and model training process can iteratively train the model to accurately detect tongue key points with reduced workload on data annotation, hence reducing the operational cost of training a key point detection model. The application may extend to other types of key point detection models.

The delta changes (δ values, delta values) used in the present disclosure can represent changes in two indicators: one is the delta change in the confidence of the model between the threshold ranges of successive training rounds, the other is the delta change in consistency of model accuracy before and after training; the two types of delta changes correspond to the confidence dimension and consistency dimension, respectively, which are two of considerations for the model in the present disclosure.

For the confidence dimension, the calculation formula for the delta change in the confidence is defined as: the delta change in the confidence=confidence after training—confidence before training. If there is a negative delta change, it indicates that there is a contradiction between a sample and the current understanding of the model, and such sample should be selected and prioritized for manual annotation for parallel training and annotation approach provided in the present disclosure. After these prioritized samples are manually annotated and updated, the samples are put into the dataset for intensive training, which is a kind of active learning based on sparse instances (SI-AL). The introduction of the delta (δ value) can dynamically track the change rule in the model's understanding, and thus provide a more flexible and efficient annotation strategy for the annotation and training of small to medium-sized datasets.

When the updated samples are annotated and put into the dataset for training, a calculation formula for delta change in consistency is set as follows: delta change in consistency=consistency after training−consistency before training, to verify the fitting ability of the model (similar inputs produce similar outputs), and to determine the stability of repeatedly evaluating the same batch of samples before and after optimization, to avoid the overfitting problem caused by repeated sample training.

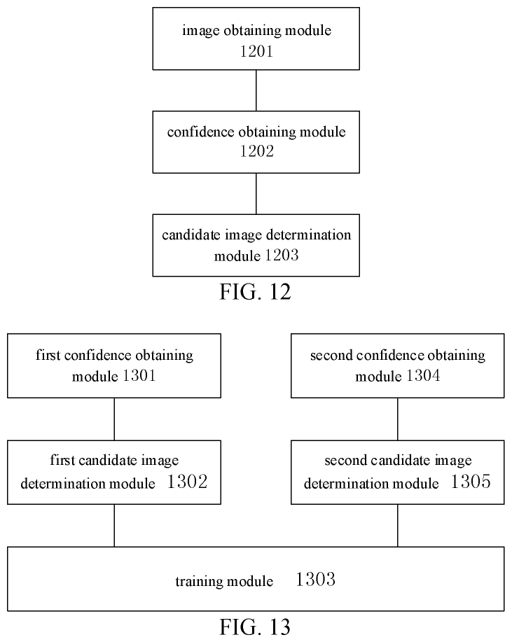

FIG. 12 shows a structural diagram of an image processing apparatus according to an embodiment of the present disclosure. As shown in FIG. 12, the image processing apparatus includes: an image obtaining module 1201 configured to obtain a first image including a tongue; a confidence obtaining module 1202 configured to input the first image into a directional state classifier to obtain a directional state and first direction confidence of the tongue in the first image, and input the first image into a key point detector to obtain a key point location and first location confidence of the tongue in the first image; and a candidate image determination module 1203 configured to determine the first image as a candidate image based on the first direction confidence and the first location confidence of the tongue in the first image, so as to perform supervised annotation.

FIG. 13 shows a structural diagram of an asynchronous training data processing apparatus according to an embodiment of the present disclosure. The asynchronous training data processing apparatus includes: a first confidence obtaining module 1301 configured to input image samples including tongues into a directional state classifier to obtain first directional states and first direction confidence of the tongues in respective image samples, and input the image samples into a key point detector to obtain first key point locations and first location confidence of the tongues in respective image samples; a first candidate image determination module 1302 configured to determine a first candidate image in the image samples based on the first direction confidence and the first location confidence of the tongues in the image samples for supervised annotation; a training module 1302 configured to train the directional state classifier and the key point detector using the first candidate image after the supervised annotation; a second confidence obtaining module 1304 configured to input non-candidate images in the image samples into the trained directional state classifier to obtain second directional states and second orientation confidence of the tongues in the non-candidate images, and input the non-candidate images into the trained key point detector to obtain second key point locations and second location confidence of the tongues in the non-candidate images; a second candidate image determination module 1305 configured to select a second candidate image from the non-candidate images based on a delta change on confidence of the directional states and key point locations of the non-candidate images for supervised annotation. The training module 1303 is further configured to train the directional state classifier and the key point detector using the second candidate image after supervised annotation.

The present disclosure designs an asynchronous candidate queuing mechanism. While we iteratively annotate a sequence of unlabeled data determined with the above mentioned prioritizing strategies, at the same time the two models are using the annotated data to perform the training process. The annotated tongue visibility, pose direction, and key point location data can be used to train for both the direction classifier and key point detector models. While a batch of training is finished, we will use the two models to re-evaluate the rest of unlabeled data samples for confidence scoring and consistency scoring, and update the delta changes, which are then used to re-prioritize the data annotation candidate samples. In contrast to a typical supervised machine learning process where data annotation is done manually in batch, then the model performs machine learning on the fully annotated dataset, our design can leverage the newly annotated data as soon as possible, avoid asking the operator to continue annotate on data sample that is less constructive to the model training. This parallel iteration is repeated until the tongue key point classifier can correctly detect the location and visibility of the rest of data in a satisfying level of confidence and consistency. This asynchronous and parallel data annotating and model training process can iteratively train the model to accurately detect tongue key points with reduced workload on data annotation, hence reducing the operational cost of training a key point detection model. The application may extend to other types of key point detection models.

In terms of model training pipeline efficiency, model confidence and consistency, when the confidence and consistency of the models are low, the system will shortlist a sequence of candidate samples that are most confusing to the models and acquire manual annotation on the candidate samples for further training. Once a newly annotated data is acquired, the model training will happen in parallel with additional data annotation processes, and once the new batch of training is completed, the list of unlabelled sample data candidates will be re-prioritized. The operator performs data annotation that is most confusing to the new models, instead of annotating data samples that are relatively redundant. This pipeline is more efficient than the typical batch processing approach where all data annotation happens before the model training. The pipeline in the present disclosure utilizes the new feedback information (annotated data) for model training and re-prioritize the data sample candidates iteratively, which is more conducive to improving the models'accuracy and consistency. This iteration process focuses data annotation on most confusing data samples, until the models accuracy, confidence, and consistency are improved to a satisfactory level. Data annotation workload can be reduced to just the right amount.

As for the model itself, we can accurately detect tongue key points (including the tip point, root (left/right/middle), middle points, left edges and right edges), being resilient to the interference from the lips and oral cavity to accurately track the fine grain pose and movement of the whole tongue, which can be used for further research and application (such as to analyze oral motor functionality and provide real-time biofeedback for speech rehab training).

The present disclosure has the following advantages:

Compared with today's advanced technology in this field, the present disclosure can solve the problem of labor intensive nature to train an accurate tongue key point detection model in various pose from optical camera and extend the recognition functionality of the existing face landmark model(s) to cover in the oral cavity and even the finer part of the tongue.

At the same time, the present disclosure adopts the asynchronous pipeline of dual-model training and prioritized data annotation on most confusing/contributive unlabeled data sample candidates. The pipeline performs model training and re-prioritize candidate samples in parallel with the data annotation process. The pipeline enables asynchronous feedback between the model training process and data annotation process, which can improve the models' accuracy, confidence and consistency with reduced data annotation workload.

In addition, the present disclosure proposes an extensible methodology and system to train custom key point detection model with reduced data annotation workload.

Finally, the present disclosure proposes a tongue key point detection dataset based on clinic data. This valuable dataset can be used to build tongue pose analysis models and for further research on oral motor functionality and empower application of real-time biofeedback for speech rehab training.

The following are analysis of possible alternative solutions for these novel features in the contents above which may also enable the present disclosure:

Alternative solutions for models capable of detecting facial feature key points:

Mediapipe:

Advantages: As an existing open-source cross-platform machine learning architecture, Mediapipe's dense network model can detect 478 facial feature key points, including lips, chin, and nose. It can infer an approximate 3D mesh representation of the face from a single camera input and perform object detection and tracking on subsequent video frames. It supports both CPU and GPU modes, and the GPU mode can also perform key point detection with low latency on mobile devices.

Disadvantage: It does not currently support tongue key point detection, which is a key limitation that prevents it from being used to detect the tongue key point portion in the present disclosure.

YOLO:

Advantages: YOLO has always been the gold standard for object detection, summarizing it as a regression problem and achieving end-to-end training and detection. The latest version (YOLOv11) introduces the new C3k2 block, which accelerates processing speed and improves performance. The C2PSA block enhances spatial attention in feature maps, improving detection accuracy for objects of different sizes and locations. Furthermore, it not only supports object detection but also extends to tasks such as pose estimation and instance segmentation, enhancing the model's applicability across various domains.

Disadvantages: The YOLO model itself is not trained for tongue key point detection and does not support this function. If it is required for tongue key point detection, a custom model needs to be trained based on the YOLO architecture, which can be implemented with or without transfer learning.

Possible alternatives suggested:

Other machine learning models or algorithms specifically designed for detecting intraoral structures or tongue key points can be explored. For example, some studies focusing on medical image processing or oral biomechanical analysis may have developed models specifically for tongue key point detection. These models may be more targeted and accurate in detecting tongue key points.

Existing models such as Mediapipe or YOLO can be improved or extended to enable them to detect tongue key points. For example, fine-tuning these models by adding specialized training data (such as images and annotated data of the tongue) may be tried to allow them to learn the features of tongue key points, thereby achieving the detection of tongue key points.

Advantages of multiple modules can be combined. Mediapipe's advantages in detecting key points on other parts of the face can be combined with other models capable of detecting tongue key points to form a more comprehensive key point detection system. For example, Mediapipe can be used first to detect key points on the face excluding the tongue, and then a dedicated tongue key point detection model can be used to detect tongue key points. The results from both models can then be fused and processed.

In summary, although Mediapipe and YOLO have their own advantages in facial key point detection and object detection, they both have certain shortcomings in the core function of detecting tongue key points in the present disclosure. Further exploration of other specialized models or improvement and combination of existing models are needed to realize the functions of the present disclosure.

It also maintains a balance between accuracy and computational efficiency, enabling faster processing and enhanced feature extraction for more accurate object detection.

However, the existing YOLO model has not been trained for tongue key point detection.

The immediate and/or future applications of the present disclosure are described below; furthermore, it is noted that modifications to the present disclosure may be made to make it applicable to other technical fields.

### 1) Immediate Applications

Clinical Assessment: The smart key point detection trainer can be utilized in clinical settings to analyze tongue posture and movements. This aids in diagnosing and monitoring patients with speech or swallowing disorders.

Speech Therapy: Speech therapists can leverage this technology to provide targeted interventions by assessing tongue positioning during therapy sessions, allowing for real-time feedback and adjustments.

Telehealth Platforms: Integrating this technology in telemedicine allows healthcare providers to remotely evaluate and monitor patients'tongue movements, enhancing access to care for individuals in remote areas.

Machine Learning for Predictive Modeling: By utilizing the annotated datasets, researchers can develop predictive models to forecast effects of the speech therapy based on tongue positioning and movement patterns, paving the way for personalized treatment plans in speech therapy and rehabilitation.

Neurogenic Disease Assessment: The technology can be employed to assess and monitor tongue movements in patients with neurogenic diseases, such as Amyotrophic Lateral Sclerosis (ALS) or Parkinson's disease. By tracking changes in tongue posture and movement over time, clinicians can gain insights into disease progression and the effectiveness of interventions.

### 2) Future Applications

Advanced Biometric Analysis: The technology could be developed further to analyze biometric characteristics of the tongue in relation to health conditions, enabling early diagnosis of diseases through machine learning models trained on tongue morphology and movement data.

Artificial Intelligence for Speech Recognition: This methodology could enhance artificial intelligence speech recognition systems by providing detailed tongue movement data, improving the accuracy of systems that rely on articulatory features for understanding speech.

Neurophysiological Research: The adaptive machine learning techniques could be applied in neuroscience to study the neural control of tongue movements, contributing to a better understanding of motor control and its implications for speech and swallowing disorders.

Cross-Language Phonetics Studies: The technology could facilitate research into phonetic variations across languages by analyzing tongue movements in different linguistic contexts, providing insights into articulatory phonetics and language acquisition.

Research in Linguistics: The present disclosure enables researchers to study the biomechanics of the tongue and its role in speech production, contributing valuable data to the fields of linguistics and phonetics.

### Modifications for Other Technical Fields

General Object Detection: The methodologies can be adapted for other object detection tasks, such as facial recognition, where reduced annotation effort is crucial.

Medical Imaging Applications: Techniques for dynamic candidate selection could enhance the accuracy of medical imaging annotations, improving the efficiency of diagnostics.

Animation and Game Development: The technology could be adapted for motion capture in animation, allowing for more realistic character movements and speech.

The above embodiments can be implemented, in whole or in part, by software, hardware, firmware, or any other combination thereof. When the above embodiments are implemented using software, the above embodiments can be implemented, in whole or in part, as a form of a computer program product. The computer program product includes one or more computer instructions or computer programs. When the computer instructions or computer programs are loaded or executed on a computer, all or part of the processes or functions according to the embodiments of the present disclosure are generated. The computer can be a general-purpose computer, a special-purpose computer, a computer network, or other programmable apparatus. The computer instructions can be stored in a computer-readable storage medium or transmitted from one computer-readable storage medium to another computer-readable storage medium. For example, the computer instructions can be transmitted from one website, computer, server, or data center to another website, computer, server, or data center via wired (e.g., infrared, wireless, microwave, etc.) means. The computer-readable storage medium can be any available medium that a computer can access or a data storage device such as a server or data center that includes one or more sets of available media. The available medium can be a magnetic medium (e.g., floppy disk, hard disk, magnetic tape), an optical medium (e.g., DVD), or a semiconductor medium. The semiconductor medium can be a solid-state drive.

An embodiment of the present disclosure also provides a computer-readable medium for storing computer program codes. The computer program includes instructions for performing the image processing method of the embodiments of the present disclosure described above. The readable medium may be a Read-Only Memory (ROM) or a Random Access Memory (RAM), and the embodiments of the present disclosure do not impose limitations on this.

The present disclosure also provides a computer-readable storage medium having a computer program stored thereon. The computer-readable storage medium stores a program product capable of implementing the methods described above in the specification. In some possible implementations, various aspects of the present disclosure may also be implemented as a form of a program product including program codes. When the computer product is run on a terminal device, the computer codes cause the terminal device to perform the steps described in the “Examples Methods” section of the specification according to various example implementations of the present disclosure.

It should be noted that the above figures are merely illustrative of the processes included in the methods according to example embodiments of the present invention, and are not intended to be limiting. It is readily understood that the processes shown in the above figures do not indicate or limit a temporal order of these processes. Furthermore, it is readily understood that these processes may be executed synchronously or asynchronously, for example, in multiple modules.

Those skilled in the art will understand that various aspects of the present disclosure can be implemented as systems, methods, or program products. Therefore, various aspects of the present disclosure can be specifically implemented in the following forms: a completely hardware implementation, a completely software implementation (including firmware, microcode, etc.), or a combination of hardware and software aspects, collectively referred to herein as a “circuit”, “module”, or “system”.

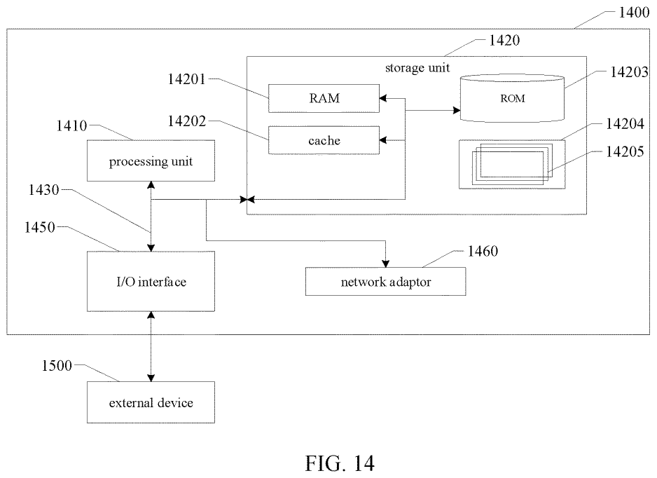

An electronic device 800 according to this implementation of the present disclosure will now be described with reference to FIG. 14. The electronic device 1400 shown in FIG. 14 is merely an example and should not be construed as limiting the functionality and scope of use of the embodiments of the present disclosure.

As shown in FIG. 14, the electronic device 1400 is presented in the form of a general-purpose computing device. The components of the electronic device 1400 may include, but are not limited to: at least one processing unit 1410, at least one storage unit 1420, and a bus 1430 connecting different system components (including the storage unit 1420 and processing unit 1410).

The storage unit stores program codes that can be executed by the processing unit 1410, causing the processing unit 1410 to perform the steps described in the “Example Methods” section of the specification according to various example embodiments of the present disclosure. For example, the processing unit 1410 can execute the following steps in FIG. 1: in S102, obtaining a first image including a tongue; in S104, inputting the first image into a directional state classifier to obtain a directional state and first direction confidence of the tongue in the first image; in S106, inputting the first image into a key point detector to obtain a key point location and first location confidence of the tongue in the first image; in S108, determining the first image as a candidate image based on the first direction confidence and first location confidence of the tongue in the first image for supervised annotation. Alternatively, the processing unit 1410 can execute the following steps in FIG. 10: in S1002, inputting image samples including tongues into a directional state classifier to obtain first directional states and first direction confidence of the tongues in respective image samples; in S1004, inputting the image samples into a key point detector to obtain first key point locations and first location confidence of the tongues in respective image samples; in S1006, determining a first candidate image among the image samples based on the first direction confidence and first location confidence of the tongues in the image samples for supervised annotation; in S1008, training the directional state classifier and the key point detector using the supervised annotated first candidate image; in S1010, inputting non-candidate images among the image samples into the trained directional state classifier to obtain second directional states and second direction confidence of the tongues in the non-candidate images; in S1012, inputting the non-candidate images into the trained key point detector to obtain second key point locations and second location confidence of the tongues in the non-candidate images; in S1014, selecting a second candidate image among the non-candidate images based on a change on confidence of the directional states and key point locations of the non-candidate images for supervised annotation, and training the directional state classifier and the key point detector using the supervised annotated second candidate image.

The storage unit 1420 may include a readable medium in the form of a volatile storage unit, such as a Random Access Memory (RAM) 14201 and/or a cache storage unit 14202, and may further include a Read-Only Memory (ROM) 14203.

The storage unit 1420 may also include a program/utility 14204 having a set (at least one) of program modules 14205, such program modules 14205 including but not limited to: an operating system, one or more application programs, other program modules and program data, and each or some combination of these examples may include an implementation of a network environment.

The bus 1430 can represent one or more of several types of bus structures, including a memory unit bus or a memory unit controller, a peripheral bus, a graphics acceleration port, a processing unit, or a local bus using any of the various bus structures.

The electronic device 1400 may also communicate with one or more external devices 1500 (e.g., a keyboard, a pointing device, a Bluetooth device, etc.), and with one or more devices that enable a user to interact with the electronic device 1400, and/or with any device that enables the electronic device 1400 to communicate with one or more other computing devices (e.g., a router, modem, etc.). This communication can be performed via an Input/Output (I/O) interface 1450. Furthermore, the electronic device 1400 can also communicate with one or more networks (e.g., Local Area Network (LAN), Wide Area Network (WAN), and/or a public network, such as the Internet) via a network adapter 1460. As shown in this figure, the network adapter 1460 communicates with other modules of the electronic device 1400 via the bus 1430. It should be understood that, although not shown in the figure, other hardware and/or software modules can be used in conjunction with the electronic device 1400, including but not limited to: microcode, a device driver, a redundant processing unit, an external disk drive array, a RAID system, a tape drive, and a data backup storage system, etc.

From the above description of the implementations, those skilled in the art will readily understand that the example implementations described herein can be implemented by software or by combining software with necessary hardware. Therefore, the technical solutions according to the implementations of the present disclosure can be embodied in the form of a software product, which can be stored in a non-volatile storage medium (such as a CD-ROM, USB flash drive, a portable hard drive, etc.) or on a network, including several instructions to cause a computing device (such as a personal computer, a server, a terminal device, or a network device, etc.) to execute the methods according to the implementations of the present disclosure.

In an example embodiment of the present disclosure, a computer-readable storage medium is also provided, on which a program product capable of implementing the methods described above is stored. In some possible implementations, various aspects of the present disclosure may also be implemented as a program product including program codes. When the program product is run on a terminal device, the program codes cause the terminal device to perform the steps according to various example implementations of the present disclosure described in the “Example Methods” section of the specification.

A program product for implementing the above-described methods according to implementations of the present disclosure is described. The program product may employ a portable compact disc read-only memory (CD-ROM) and include program codes, and may run on a terminal device, such as a personal computer. However, the program product of the present disclosure is not limited thereto. The readable storage medium herein may be any tangible medium containing or storing programs that may be used by or in conjunction with an instruction execution system, apparatus, or device.

The program product may employ any combination of one or more readable media. The readable medium may be a readable signal medium or a readable storage medium. The readable storage medium may be, for example, but not limited to: an electrical, magnetic, optical, electromagnetic, infrared, or semiconductor system, apparatus, or device, or any combination thereof. More specific examples of the readable storage medium (a non-exhaustive list) include: an electrical connection having one or more wires, a portable disk, a hard disk, a Random Access Memory (RAM), a Read-Only Memory (ROM) , an Erasable Programmable Read-Only Memory (EPROM or flash memory), an optical fiber, a portable Compact Disk Read-Only Memory (CD-ROM), an optical storage device, a magnetic storage device, or any suitable combination thereof.

The computer-readable signal medium may include data signals propagated in baseband or as part of a carrier wave, carrying readable program codes. Such propagated data signals may take various forms, including but not limited to electromagnetic signals, optical signals, or any suitable combination thereof. A readable signal medium may also be any readable medium other than a readable storage medium. Such readable medium is capable of sending, propagating, or transmitting programs for use by or in conjunction with an instruction execution system, apparatus, or device.

The program codes contained on the readable medium may be transmitted using any suitable medium, including but not limited to wireless, wired, optical fiber, RF, etc., or any suitable combination thereof.

The program codes for performing the operations of the present disclosure can be written in any combination of one or more programming languages, including object-oriented programming languages such as Java and C++, and conventional procedural programming languages such as “C” or similar procedural programming languages. The program codes can be executed entirely on a user computing device, partially on a user device, as a standalone software package, partially on a user computing device and partially on a remote computing device, or entirely on a remote computing device or server. In cases involving a remote computing device, the remote computing device can be connected to a user computing device via any type of network, including a Local Area Network (LAN) or a Wide Area Network (WAN), or it can be connected to an external computing device (e.g., via the Internet provided by an Internet service provider).

It should be noted that although several modules or units in a device used to perform actions have been mentioned in the detailed description above, this division is not mandatory. In fact, according to implementations of the present disclosure, the features and functions of two or more modules or units described above can be embodied in one module or unit. Conversely, the features and functions of one module or unit described above can be further divided and embodied by multiple modules or units.

Furthermore, although the steps of the methods in the present disclosure are described in a specific order in the accompanying drawings, this does not require or imply that the steps must be performed in that specific order, or that all the steps shown must be performed to achieve the desired result(s). Additionally or alternatively, some steps may be omitted, multiple steps may be combined into one step, and/or one step may be broken down into multiple steps, and so on.

From the above description of the implementations, those skilled in the art will readily understand that the example implementations described herein can be implemented by software or by combining software with necessary hardware. Therefore, the technical solutions according to the implementations of the present disclosure can be embodied in the form of a software product, which can be stored in a non-volatile storage medium (such as a CD-ROM, USB flash drive, external hard drive, etc.) or on a network, including several instructions to cause a computing device (such as a personal computer, a server, a mobile terminal, or a network device, etc.) to execute the methods according to the implementations of the present disclosure.

Other implementations of the present disclosure will readily occur to those skilled in the art upon consideration of the specification and practice of the invention disclosed herein. This application is intended to cover any variations, uses, or adaptations of the present disclosure that follow the general principles of the present disclosure and include common knowledge or customary techniques in the art not disclosed herein. The specification and examples are to be considered as illustrative only, and the true scope and spirit of the present disclosure are indicated by the appended claims.

1. An image processing method, comprising:
obtaining a first image comprising a tongue;
inputting the first image into a directional state classifier to obtain a directional state and first direction confidence of the tongue in the first image;
inputting the first image into a key point detector to obtain a key point location and first location confidence of the tongue in the first image; and
determining the first image as a candidate image according to the first direction confidence and the first location confidence of the tongue in the first image so as to perform supervised annotation.

2. The method according to claim 1, wherein the method further comprises:
training the directional state classifier and the key point detector using the candidate image after annotation.

3. The method according to claim 1, wherein determining the first image as the candidate image according to the first direction confidence and the first location confidence of the tongue in the first image comprises:
determining the image as the candidate image according to the first direction confidence and the first location confidence of the tongue in the first image, and consistency of the directional state and the key point location of the tongue in the first image.

4. The method according to claim 1, wherein the directional state of the tongue comprises: up, down, left, right, pending, unseen; and/or
wherein the key point location of the tongue comprises: a tip of the tongue, a root of the tongue, a middle point of the tongue, a left edge of the tongue, and a right edge of the tongue.

5. The method according to claim 4, wherein the root of the tongue comprises a left edge of the root of the tongue, a center of the root of the tongue, and a right edge of the root of the tongue.

6. The method according to claim 2, further comprising:
obtaining a second image comprising a tongue;
inputting the second image into the directional state classifier to obtain a first directional state and first direction confidence of the tongue in the second image;
inputting the second image into the key point detector to obtain a first key point location and first location confidence of the tongue in the second image;
determining the second image to be a non-candidate image according to the first direction confidence and the first location confidence of the tongue in the second image;
inputting the second image into the directional state classifier after training to obtain a second directional state and second direction confidence of the tongue in the second image;
inputting the second image into the key point detector after training to obtain a second key point location and second location confidence of the tongue in the second image; and
determining the second image as a candidate image according to a delta change on confidence of the directional state and the key point location of the second image, so as to perform the supervised annotation.

7. The method according to claim 6, wherein the delta change on confidence is equal to confidence after training minus confidence before training,
wherein determining the second image as the candidate image according to the delta change on confidence of the directional state and the key point location of the second image comprises:
if the delta change on confidence of the directional state of the second image and/or the delta change on confidence of the key point location of the second image are negative, determining the second image to be the candidate image.

8. The method according to claim 3, further comprising:
wherein determining the directional state of the tongue in the first image specifically comprises:
determining a bounding box of a mouth part to fit lips;
through a relative location of a tip of the tongue relative to a middle point of the bounding box and a key point of a root of the tongue, forming positive and negative changes in an angle of an arrow relative to a Y-axis of a face relative coordinate system to further determine changes of the tongue in four directions of up, down, left, and right;
determining an angle of deflection of the tongue through multiple key points of the tip of the tongue, and if the angle of deflection is within a specified threshold angle, determining the tongue as a “pending” state, that is, the tongue has been recognized but does not stick out in any direction; and
determining a failure to detect the tip or root part of the tongue as a “unseen” state.

9. The method according to claim 3, further comprising:
when a root of the tongue is visible, setting three key points that form an arrow shape for the tip and root of the tongue, respectively, wherein the three key points of the root of the tongue are set at a middle point of the root of the tongue, a left edge of the root of the tongue and a right edge of the root of the tongue;
for the three key points on the tip of the tongue, fixing a center point of the tip of the tongue as an exact location of the tip of the tongue, and extending other two key points to a middle point of a left edge of the tongue and a middle point of a right edge of the tongue, respectively, to determine a direction of the tip of the tongue and the exact location of the tip of the tongue;
determining an overall direction of the tongue through an angle of deflection between the three key points of the tip of the tongue;
calculating coordinates of a middle point through a distance between an exact point of the tip of the tongue and the middle point of the root of the tongue in a spatial dimension, and then according to a threshold value of the “pending” state, determining a region of the “pending” state by the distance of the middle point;
and/or
when the root of the tongue is not visible, for the three key points on the tip of the tongue, fixing the center point of the tip of the tongue as the exact location of the tip of the tongue, and extending the other two key points to the middle point of the left edge of the tongue and the middle point of the right edge of the tongue, respectively, to determine the direction of the tip of the tongue and the exact location of the tip of the tongue;
determining the overall direction of the tongue through the angle of deflection between three key points of the tip of the tongue; and
calculating the coordinates of the middle point through a distance between the exact point of the tip of the tongue and a center point of the mouth part in the spatial dimension, and then according to the threshold value of the “pending” state, determining the region of the “pending” state by the distance of the middle point.

10. The method according to claim 3, wherein determining the consistency based on the directional state and key point location of the tongue in the first image comprises:
determining directional information of the tongue in the first image based on the key point location of the tongue in the first image; and
determining the consistency based on the directional state of the tongue in the first image and the directional information of the tongue in the first image.

11. An asynchronous training data processing method, comprising:
inputting image samples comprising tongues into a directional state classifier to obtain first directional states and first direction confidence of tongues in respective image samples;
inputting the image samples into a key point detector to obtain first key point locations and first location confidence of the tongues in respective image samples;
determining a first candidate image among the image samples according to the first direction confidence and the first location confidence of the tongues in the image samples for supervised annotation;
training the directional state classifier and the key point detector using the first candidate image after the supervised annotation;
inputting non-candidate images among the image samples into the directional state classifier after training to obtain second directional states and second direction confidence of tongues in the non-candidate images;
inputting the non-candidate images into the key point detector after training to obtain second key point locations and second location confidence of the tongues in the non-candidate image;
selecting a second candidate image among the non-candidate images according to a delta change on confidence of the directional states and key point locations of the non-candidate images for supervised annotation; and
training the directional state classifier and the key point detector using second candidate image after the supervised annotation.

12. The method according to claim 11, further comprising:
determining first consistency according to the first directional states and the first key point locations of the tongues in the image samples;
determining the first candidate image among the image samples according to the consistency of the image samples for supervised annotation; and
determining second consistency of the non-candidate images according to the second directional states and the second key point locations of the tongues in the non-candidate image;
determining the second candidate image among the non-candidate images according to a delta change on consistency of the non-candidate images for supervised annotation.

13. The method according to claim 11, wherein the directional state of the tongue comprises: up, down, left, right, pending, unseen; and/or
wherein the key point location of the tongue comprises: a tip of the tongue, a root of the tongue, a middle point of the tongue, a left edge of the tongue, and a right edge of the tongue.

14. The method according to claim 13, wherein the root of the tongue comprises a left edge of the root of the tongue, a center of the root of the tongue, and a right edge of the root of the tongue.

15. An electronic device comprising:
a processor; and
a memory for storing executable instructions for the processor;
wherein the processor is configured to execute the executable instructions to:
obtain a first image comprising a tongue;
input the first image into a directional state classifier to obtain a directional state and first direction confidence of the tongue in the first image;
input the first image into a key point detector to obtain a key point location and first location confidence of the tongue in the first image; and
determine the first image as a candidate image according to the first direction confidence and the first location confidence of the tongue in the first image so as to perform supervised annotation.

16. A computer-readable storage medium, wherein a computer program is stored on the computer-readable storage medium, and when the computer program is executed by a processor, the image processing method according to claim 1 is implemented.
